(19) United States
(12) Patent Application Publication
(10) Pub. No.: US 2009/0003778 A1
(43) Pub. Date: Jan. 1, 2009

(54) Fiber optic cable assembly

(76) Inventors: Robert Bruce Elkins, II, Hickory, NC (US); Brenda Dianne Craig, Claremont, NC (US); Lars Kristian Nlelsen, Denver, NC (US); Michael Todd Faulkner, Granite Falls, NC (US)

Correspondence Address: CORNING INCORPORATED, INTELLECTUAL PROPERTY DEPARTMENT, SP-TI-3-1, CORNING, NY, 14831, US

(21) Appl. No.: 11/823,961

(22) Filed: Jun. 29, 2007

(51) Int. Cl. G02B 6/255

(52) U.S. Cl. 385/95

(57) ABSTRACT

A fiber optic cable assembly comprising a fiber optic cable having a plurality of optical fibers disposed within a cable sheath and having an access point through the cable sheath for accessing and preterminating at least one of the plurality of optical fibers, at least one tether attached about the access point, the at least one tether having at least one optical fiber disposed within a cable sheath, and a flexible closure substantially encapsulating the access point, a portion of the fiber optic cable and a portion of the at least one tether. At least one preterminated fiber of the fiber optic cable is spliced to the at least one optical fiber of the at least one tether, and spliced together fiber portions of the at least one preterminated fiber and the at least one tether optical fiber are not maintained within a splice tube.

### BACKGROUND OF THE INVENTION

1. Field of The Invention

The present invention relates generally to flexible fiber optic cable assemblies, and specifically, to low-profile cable assemblies having network access points for branching optical fibers to one or more discrete tethers, and cable assemblies including optional armor, armor bridging structure and variable preferential stiffness.

2. Technical Background

Fiber optic cable assemblies are being developed to extend the reach of optical networks to subscribers. Examples of developing assemblies used for this purpose often include at least a fiber optic distribution cable containing a plurality of optical fibers, wherein pre-selected optical fibers are accessed through the cable sheath at a point mid-span along the cable. The pre-selected optical fibers are cut, or “preterminated,” and typically spliced to other optical fibers of drop or tether cables in order to create branches off of the distribution cable. These drop cables or tethers are often terminated in one or more connectors and can be routed to a subscriber, network connection terminal or any desired location or assembly within reach of a tether. Thus, cable assemblies having tap points are instrumental in providing “fiber-to-the-curb” (FTTC), “fiber-to-the-business” (FTTB), “fiber-to-the-home” (FTTH), or “fiber-to-the-premises” (FTTP), all of which are referred to generically herein as “FTTx.”

While certain cable assemblies are known, prior designs have had difficulty in achieving multiple discrete tethers while maintaining a low-profile, preferably less than about 2 inches at a largest cross-sectional diameter, and even more preferably less than about 1.5 inches in diameter. Further, prior designs have had difficulty in achieving multiple discrete tethers exiting a common end or each end of a tap point. Specifically, when two or more tethers transition to a splice tube where excess fiber length is managed, the tethers must be co-located in a manner that does not allow their fusion splice protectors to interfere. This is difficult given that the diameter of the splice tube is not able to accommodate two co-located splice protectors. Managing multiple splices longitudinally with respect to one another is difficult when trying to achieve a low loss splice and are constrained by fiber length. Each splice or re-splice attempt to maintain low optical loss yet maintain a local relationship uses limited available distribution cable fiber. Further, effort to do so requires additional manufacturing skill and labor. Still further, the transition of multiple tethers into a splice tube requires a hermetic seal to prevent overmold polyurethane from entering during overmolding processes, and multiple inputs to a common tube are more difficult to seal. Thus, in order to eliminate radial, longitudinal and sealing constraints as well as reduce manufacturing complexity, it would be desirable to develop a cable assembly that eliminated the use of a splice tube altogether.

Accordingly, it would be desirable to develop low-profile, flexible cable assemblies that require a lesser amount of structure and difficulty to manufacture than current cable assembly designs. Further, it would be desirable to provide a flexible cable assembly having multiple discrete tethers that exit from either a single or both end of an access point in order to provide multiple branches. A tubeless design eliminates the challenge of transitioning multiple tethers to a common splice tube and eliminates the need to have the final spliced length of each tether in a fixed relationship to one another. Additional desirable cable assemblies may include preferential bend elements added to protect the network access point and optical fibers. Other additional desirable cable assemblies may include armor.

### SUMMARY OF THE INVENTION

In various embodiments, the present invention provides low-profile flexible cable assemblies having at least one, and in some embodiments, multiple discrete tethers. The present invention eliminates the splice tube found in conventional flexible network access point designs, making the cable assembly easier to manufacture and less expensive. In one embodiment, the cable assembly includes a fiber optic distribution cable having a plurality of optical fibers contained within a cable sheath. Pre-selected optical fibers are accessed through an access point in the cable sheath and are terminated. The terminated optical fibers are then spliced or otherwise optically connected to optical fibers of the one or more tethers. As described herein, a tether typically includes a lesser number of optical fibers than a fiber optic distribution cable.

In another embodiment, the present invention provides a cable assembly including a distribution cable and one or more tethers attached about a network access point along the cable length. The cable assembly further includes bend performance optical fiber capable of handling increased fiber strain without appreciable loss. The terminated fibers at the access point are directly bonded into the polyurethane matrix and are largely subject to the same stress as the adjacent material. In preferred embodiments, the fibers are placed as close to the designed neutral axis of the assembly to minimize stress. One embodiment may include a viscous boundary layer introduced on the fibers and covering them to prevent the polyurethane from bonding directly to the fibers. The viscous boundary layer may include greases or gels (similar to many standard cable filling compounds) that ultimately create a fluid plenum for the fibers to exist within. The plenum functions to accommodate optical loss due to bending and axial stress. Cable assembly variations may include additional structure such as troughs that provide a location to directly apply the viscous boundary layer in a controlled, repeatable fashion. The trough may also act as a preferential bending element. The viscous boundary layer may provide additional protection against water intrusion.

Other cable assembly variations may include a clearance that can be filled with gel while housing the one or more splice protectors. Axial tension placed on the fiber(s) in the clearance allows the splice protector(s) to translate within the clearance without causing significant axial stress and optical attenuation in the fiber(s).

In other embodiments, the present invention provides a flexible optical closure that includes at least one overmolded portion associated with an optical access location of a pre-engineered cable assembly. The access location provides access to one or more optical fibers of the distribution cable. In preferred embodiments, the flexible optical closure, and optical fibers therein, are capable of bending to about the minimum bend radius of the fiber optic cable upon which the flexible closure is installed. The flexible closure can be bent with a force about equal to the force required to bend the cable itself without the flexible closure attached to the cable. The bending range of the flexible closure is from about 0 degrees to about 360 degrees, allowing the flexible closure to be bent about a radius, twisted, and bent in S-shaped or U-shaped arcs. The flexible closure can be bent and/or twisted in virtually any direction. In preferred embodiments, the flexible closure has a preferential bend, yet it is flexible and twistable, and in some embodiments have a variable preferential stiffness. The flexible closure preferably has an outer diameter sufficiently small enough to allow the pre-engineered cable assembly to be installed in buried and aerial networks through conduits or over aerial installation sheave wheels, pulleys and other installation equipment or hardware. Further, the flexible closure has a diametral ratio (ratio of the at least one overmold portion outer diameter to the cable outer diameter) from about 1.0 to about 5.0, preferably about 2.0. Intrinsic material properties of the overmolded closure contribute to the flexible, yet sturdy, characteristic of the flexible optical closure. The molded portion of the flexible closure is formed, for example, by pouring or injecting a curable fluid material about optical components in a mold, and curing the material, so that the cured material defines a flexible yet durable closure about the components.

In yet other embodiments, cable assemblies may include one or more strength members of constant cross-section where its radial position relative to the distribution cable over the length of the flexible network access point assembly varies and thus varies the local preferential stiffness of the assembly. Variations may include utilizing one or more strength members with a non-constant cross-section and where their longitudinal axis maintains a constant radial position relative to the distribution cable over the length of the assembly to vary the local preferential stiffness. Another variation may utilize a strength member with variable stiffness properties over the axial length to vary the local preferential stiffness. Another variation may include using coupled constant cross-section members in parallel of varying lengths to vary the local preferential stiffness.

In yet other embodiments, the cable assembly includes a flexible network access point built on an armored cable. The armor is bridged or remains intact at the fiber access point to pass required electrical connectivity tests. One embodiment includes a bridging element such as an electrical wire, strap, clip or rod to electrically connect the cut armor. The bridging element may further function as the preferential bend element. The bridging element may also act as a fiber transition guard to protect the fibers from crush. An alternative embodiment keeps a significant portion of the armor intact while still being able to access the fibers through the armor.

Additional features and advantages of the invention are set out in the detailed description which follows, and will be readily apparent to those skilled in the art from that description or recognized by practicing the invention as described herein, including the detailed description which follows, the claims, as well as the appended drawings.

### BRIEF DESCRIPTION OF THE DRAWINGS

FIG. 1 is a perspective view of a cable assembly without a splice tube and including a network access point and a preterminated fiber helically wrapped about the cable core and routed to a tether.

FIG. 2 is a perspective view of another cable assembly without a splice tube and including a network access point and multiple fibers helically wrapped around the cable core and routed to discrete tethers that are attached at opposite ends of the access point.

FIG. 3 is a perspective view of a cable assembly having a flexible network access point, armor, and structure for bridging a cut portion of the armor.

### DETAILED DESCRIPTION OF THE PREFERRED EMBODIMENTS

Reference will now be made in detail to the present preferred embodiments of the invention, and examples of which are illustrated in the accompanying drawings. Whenever possible, the same reference numerals will be used throughout the drawings to refer to the same or like parts. It is to be understood that both the foregoing general description and the following detailed description present exemplary embodiments of the present invention, and provide an overview or framework for understanding the nature and character of the invention as claimed.

Referring to the figures, the present invention provides various embodiments of low-profile, flexible cable assemblies. The embodiments shown include a flexible protective covering for substantially sealing an exposed portion of the cable created when pre-selected optical fibers are accessed through the sheath and terminated. The closure is referred to herein as an “overmold.” The flexible overmold is combined with flexible optical cables to provide flexible cable assemblies that are durable yet sufficiently flexible so as to permit installation using known installation methods and equipment. In contrast to rigid closures, a flexible overmold of the present invention is bendable and twistable and may be installed around installation pulleys and within small diameter conduit while maintaining structural integrity, sealing, and optical and mechanical performance.

An exemplary overmolding process may include: (i) arranging portions of the cable assembly about a network access point in, for example, a cavity made by a molding tool, die or die-casting; (ii) introducing a curable material in fluid form into the cavity, the fluid essentially flooding the cavity, penetrating interstices around and about the assembly, and essentially covering the assembly; and (iii) curing the curable material within suitable curing conditions. Exemplary molding processes include, but are not limited to, pour and injection molding, pressure molding, and die casting. Alternative exemplary processes may include vacuum and heat forming processes. Also, the overmold can be applied by extruding a flexible closure material while pulling the assembly through a die. The overmold is preferably a monolithic form. Beneath the overmold material may be disposed a flexible cover material, for example a paper, plastic, tape or wrapping material, to cover at least a portion of the assembly prior to applying the molding material so that the material will not directly contact components. In other embodiments, the molding material may directly contact the underlying components. Exemplary overmold materials may include polyurethanes, silicones, thermoplastics, thermosets, elastomers, UV curable materials and like materials taken alone or in combination. The overmold may further include additives, plasticizers, flame retardant additives, dyes and colorants. Overmold flexibility and crush-resistance may be enhanced or relaxed based upon application. The term “curable” may include thermoplastic hardening, chemical additive curing, catalyst curing including energy curing as by heat or light energy, and phase changes.

In the various embodiments described herein, a cable assembly of the present invention includes a fiber optic distribution cable comprising at least a cable sheath having a predetermined number of optical fibers contained within. The predetermined number of optical fibers may be individualized, ribbonized, or combinations of each. The distribution cable may further comprise strength members, strength yarns, one or more buffer tubes, and water-sellable tapes or foams, among other known cable components. The cable may have a round or a non-round cross-section. Distribution cable types suitable for use in the present invention include, but are not limited to, Altos™, SST™ and RPX™ cables available from Corning Cable Systems of Hickory, N.C. Although only one network access point is shown on a distribution cable, it is envisioned that a distribution cable may include more than one network access point along its length for attaching multiple tethers at multiple access points. Each access point is used to access and terminate pre-selected optical fibers within the distribution cable.

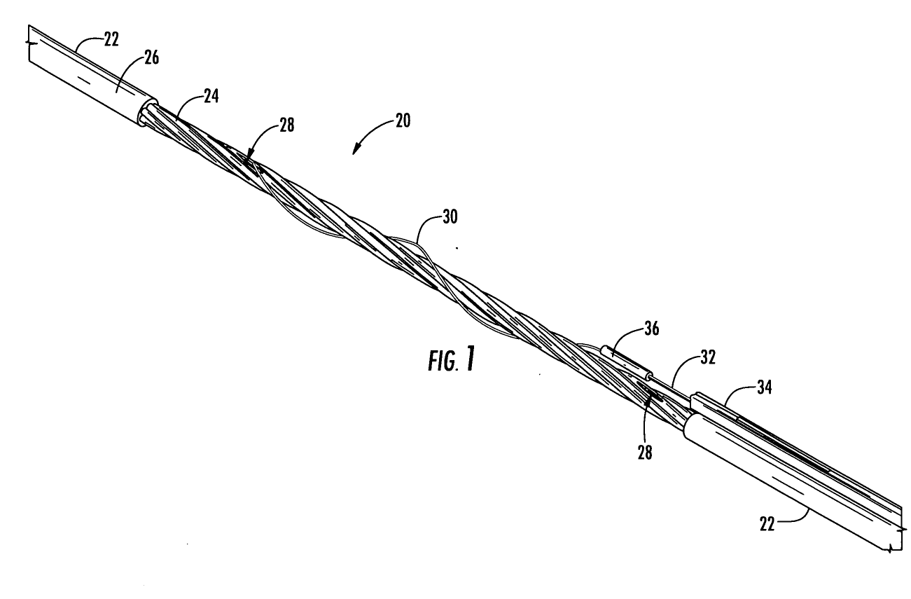

Referring to FIG. 1, a pre-engineered cable assembly 20 is shown with the flexible closure removed in order to illustrate the underlying structure. The assembly shown includes a distribution cable 22 including a plurality of fiber containing buffer tubes 24 that are helically stranded. A predetermined length of the cable sheath 26 is removed to expose the underlying buffer tubes. The length of the removed portion of cable sheath corresponds to the length of fiber required to be removed from the cable for splicing. The buffer tubes 24 are accessed at one or more buffer tube access points 28. In one example, pre-selected fibers are cut at a first access point 28 and fished out through a second access point to provide length for splicing. One optical fiber 30 or optical fiber ribbon is shown removed from its respective buffer tube and wrapped about the buffer tube core. The term “preterminated” is used herein to refer to an optical fiber 30 that it is terminated a point short of its total installed length. The fiber 30 is spliced to a corresponding number of optical fibers 32 of a tether 34 and protected within a splice protector 36. The tether 34 is preferably maintained along with the distribution cable 22 during installation and is then unlashed and routed to a network connection terminal, network interface device, multi-port connection terminal or any other location or device within reach of the tether. The tether 34 may have any length. The tether 34 typically includes a cable sheath and terminates in at least one connector (not shown), such as a single fiber connector, duplex connector or multi-fiber connector. Common multi-fiber connectors often include 4-fiber, 6-fiber, 8-fiber and 12-fiber variations.

The low-profile, flexible cable assembly 20 eliminates the splice tube found in conventional flexible network access point designs, making the cable assembly easier to manufacture and less expensive. The cable assembly may optionally include bend performance optical fiber capable of handling increased fiber strain without appreciable loss. The terminated fiber 30 at the access point is directly bonded into the polyurethane matrix and is largely subject to the same stress as the adjacent material. The fiber 30 is preferably placed as close to the designed neutral axis of the assembly to minimize stress. One embodiment may include a viscous boundary layer introduced on the fiber to prevent the polyurethane from bonding directly to the fiber. The viscous boundary layer may include greases or gels (similar to many standard cable filling compounds) that ultimately create a fluid plenum for the fiber to exist within. The plenum functions to accommodate optical loss due to bending and axial stress. Cable assembly variations may include additional structure such as troughs that provide a location to directly apply the viscous boundary layer in a controlled, repeatable fashion. The trough may also act as a preferential bending element. The viscous boundary layer may provide additional protection against water intrusion. Other cable assembly variations may include a clearance that can be filled with gel while housing the splice protector 36. Axial tension placed on the fiber in the clearance allows the splice protector to translate within the clearance without causing significant axial stress and optical attenuation in the fiber.

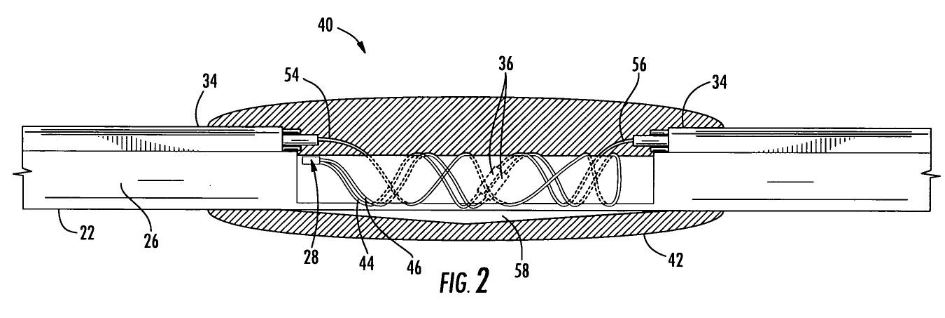

Referring to FIG. 2, another embodiment of a cable assembly 40 devoid of a splice tube and including a network access point and multiple fibers helically wrapped around the cable core and routed to discrete tethers that are attached at opposite ends of the access point is shown. The flexible closure 42 is shown in cross-section to illustrate the underlying structure of the access point. As in the previous embodiment, the assembly includes a distribution cable 22 including a plurality of fiber containing buffer tubes (not shown). The buffer tubes are not shown for clarity to illustrate the wrapping of preterminated fibers 44 and 46 about the cable core. A predetermined length of the cable sheath 26 is removed to expose the underlying buffer tubes. A buffer tube is accessed at at least access point 28.

Optical fiber 44 is shown exiting access point 28. Optical fiber 44 is wrapped about the core of buffer tubes and is spliced to optical fiber 54 and protected within splice protector 36. The spliced together fibers are wrapped about the buffer tube core in a first direction, and are then wrapped back in a reverse direction such that fiber 54 exits through a first tether 34 shown on the left side of the assembly. Optical fiber 46 exits access point 28 and is wrapped about the core of buffer tubes and spliced to optical fiber 56 and protected within another splice protector 36. The fibers are wrapped in one direction and exit through a second tether 34 shown on the right side of the assembly. Fibers may be routed between helix groves or spaces created by removing buffer or filler tube. The core may be covered with or without cable filling compound and then overmolded. “Spliced together portions of optical fibers” is used herein to describe the portions of the fibers from the cable and tethers that are outside of the cable sheath and wrapped about the core of the distribution cable.

The cable assembly 40 as shown includes discrete tethers that exit opposite ends of the access point. In alternative embodiments, more than one tether may be provided, and in the case of multiple tethers, multiple tethers may exit out of the same end of the access point. Thus, embodiments of the present invention are able to provide custom tether arrangements. The fibers 44 and 46 are spliced to corresponding numbers of optical fibers. Splice protectors may be staggered to maintain a low-profile. Tethers 34 are preferably maintained along with the distribution cable 22 during installation and a portion of each tether is preferably strain relieved within a portion of the overmold 42. Space may be provided between the distribution cable and tethers for filling with overmold material. In alternative embodiments, the tethers may contact the distribution cable and overmold material is then applied to cover both cables.

In optional embodiments, the assembly may include a preferential bend element 58 having a predetermined shape to provide variable preferential stiffness. When considering the composite preferential stiffness profile of a cable assembly, as a function of axial position, discontinuities exist where material and/or hardware transition as axial position varies. Abrupt composite preferential stiffness discontinuities, determined by comparing the composite preferential stiffness before a material and/or hardware to the preferential stiffness after the transition, can reduce the bending performance. Reduced bending performance occurs because discontinuous composite stiffness profiles are accompanied by discontinuous stress distributions. Stress concentrations may cause radial cracks to form along the overmold if the bending stress is great enough to overcome the overmold materials tensile strength or if the internal structure providing stiffness to the assembly is close to the surface of the overmold.

One example of a preferential bend element includes a strength member of constant cross-section where its radial position relative to the distribution cable over the length of the assembly varies and thus varies the local preferential stiffness of the assembly. Variations include utilizing a strength member with a non-constant cross-section (shown at reference number 58) and where its longitudinal axis maintains a constant radial position relative to the distribution cable over the length of the assembly to vary the local preferential stiffness. Another variation utilizes a strength member with variable stiffness properties over the axial length to vary the local preferential stiffness. Still another variation includes using coupled constant cross-section members in parallel of varying lengths to vary the local preferential stiffness. All of the variations may be used in conjunction with one another to create alternative permutations.

Still referring to FIG. 2, optical fibers 44, 46, 54 and 56 include any number of individual or ribbonized optical fibers. The preterminated and tether fibers may be directly bonded into the polyurethane matrix, thus largely subjecting them to the same stress as the adjacent material. The fibers are preferably wrapped close to the designed neutral axis of the assembly to minimize stress. One embodiment may include a viscous boundary layer introduced on the fiber to prevent the overmold polyurethane from bonding directly to the fiber. The viscous boundary layer may include greases or gels (similar to many standard cable filling compounds) that ultimately create a fluid plenum for the fiber to exist within. The plenum functions to accommodate optical loss due to bending and axial stress. Cable assembly variations may include additional structure such as troughs that provide a location to directly apply the viscous boundary layer in a controlled, repeatable fashion. The trough may also act as a preferential bending element. The viscous boundary layer may provide additional protection against water intrusion. Other cable assembly variations may include a clearance that can be filled with gel while housing the splice protector. Axial tension placed on the fiber in the clearance allows the splice protector to translate within the clearance without causing significant axial stress and optical attenuation in the fiber.

One or more of the optical fibers 44, 46, 54 and 56 may include bend performance optical fiber capable of handling increased stress and bending with suffering appreciable loss. A bend performance fibers as described herein is intended to include nanostructured fibers of the type available from Corning, Inc., of Corning, N.Y., including, but not limited to, single mode, multi-mode, bend performance fiber, bend optimized fiber and bend insensitive optical fiber. Nanostructured fiber is advantageous in that allows cable assemblies to have aggressive bending while optical attenuation remains extremely low. One example of a bend performance optical fiber includes a core region and a cladding region surrounding the core region, the cladding region comprising an annular hole-containing region comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than about 1310 nm, in other embodiments also greater than 1260 nm. The optical fibers provide a mode field at a wavelength of 1310 nm preferably greater than 8.0 microns, more preferably between about 8.0 and 10.0 microns.

In some embodiments, the nanostructured optical fibers disclosed herein comprises a core region disposed about a longitudinal centerline, and a cladding region surrounding the core region, the cladding region comprising an annular hole-containing region comprised of non-periodically disposed holes, wherein the annular hole-containing region has a maximum radial width of less than 12 microns, the annular hole-containing region has a regional void area percent of less than about 30 percent, and the non-periodically disposed holes have a mean diameter of less than 1550 nm. By “non-periodically disposed” or “non-periodic distribution”, we mean that when one takes a cross-section (such as a cross-section perpendicular to the longitudinal axis) of the optical fiber, the non-periodically disposed holes are randomly or non-periodically distributed across a portion of the fiber. Similar cross sections taken at different points along the length of the fiber will reveal different cross-sectional hole patterns, i.e., various cross-sections will have different hole patterns, wherein the distributions of holes and sizes of holes do not match. That is, the holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than about 95% of and preferably all of the holes exhibit a mean hole size in the cladding for the optical fiber which is less than 1550 nm, more preferably less than 775 nm, most preferably less than 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes.

The optical fibers disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes. In one set of embodiments, the core region includes doped silica to provide a positive refractive index relative to pure silica, e.g. germania doped silica. The core region is preferably hole-free.

Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

Multimode fibers may also be used herein which comprise a graded-index core region and a cladding region surrounding and directly adjacent to the core region, the cladding region comprising a depressed-index annular portion comprising a depressed relative refractive index, relative to another portion of the cladding (which preferably is silica which is not doped with an index of refraction altering dopant such as germania or fluorine). Preferably, the refractive index profile of the core has a parabolic shape. The depressed-index annular portion may comprise glass comprising a plurality of holes, fluorine-doped glass, or fluorine-doped glass comprising a plurality of holes. The depressed index region can be adjacent to or spaced apart from the core region. Multimode optical fiber disclosed herein exhibits very low bend induced attenuation, in particular very low macrobending. In some embodiments, high bandwidth is provided by low maximum relative refractive index in the core, and low bend losses are also provided. In some embodiments, the core radius is large (e.g. greater than 20 μm), the core refractive index is low (e.g. less than 1.0%), and the bend losses are low. Preferably, the multimode optical fiber disclosed herein exhibits a spectral attenuation of less than 3 dB/km at 850 nm.

The numerical aperture (NA) of the optical fiber is preferably greater than the NA of the optical source directing signals into the fiber; for example, the NA of the optical fiber is preferably greater than the NA of a VCSEL source. The bandwidth of the multimode optical fiber varies inversely with the square of Δ1_{MAX}. For example, a multimode optical fiber with Δ1_{MAX} of 0.5% can yield a bandwidth 16 times greater than an otherwise identical multimode optical fiber except having a core with Δ1_{MAX} of 2.0%. In some embodiments, the core extends radially outwardly from the centerline to a radius R1, wherein 12.5≦R1≦40 microns. In some embodiments, 25≦R1≦32.5 microns, and in some of these embodiments, R1 is greater than or equal to about 25 microns and less than or equal to about 31.25 microns. The core preferably has a maximum relative refractive index, less than or equal to 1.0%. In other embodiments, the core has a maximum relative refractive index, less than or equal to 0.5%. Such multimode fibers preferably exhibit a 1 turn 10 mm diameter mandrel attenuation increase of no more than 1.0 dB, preferably no more than 0.5 dB, more preferably no more than 0.25 dB, even more preferably no more than 0.1 dB, and still more preferably no more than 0.05 dB, at all wavelengths between 800 and 1400 nm.

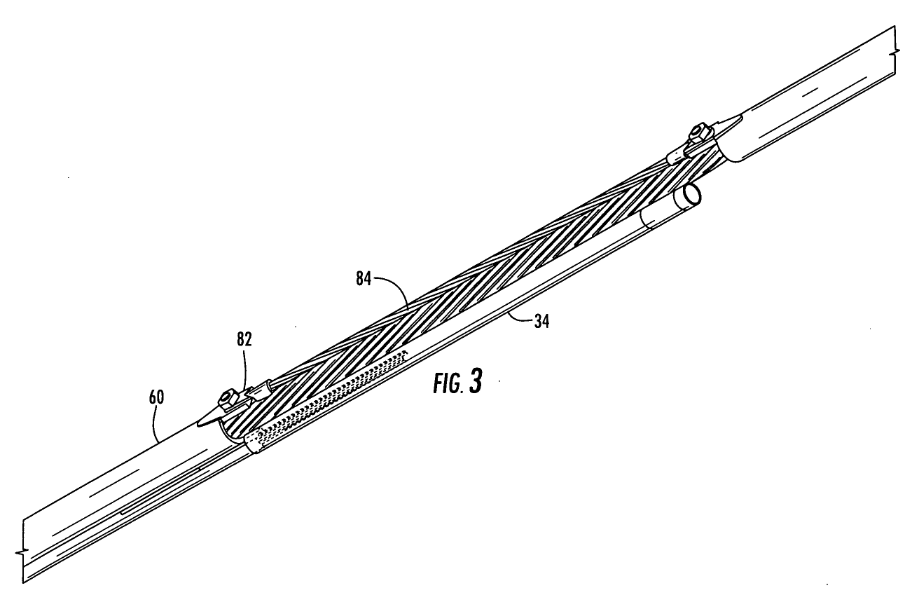

Referring to FIG. 3, an embodiment of an armored cable assembly is shown including armor bridging with clips 82 and a braided grounding strap 84. The clips are located on opposite sides of the access point. The cable assembly is shown without detailing the fibers or showing the fibers exiting the distribution cable or entering the tether to clearly illustrate bridging the armor and the structure used to do so. In armored cable embodiments, armor removed at a cable access point is bridged using a bridging element such as an electrical wire, strap, clip or rod to electrically connect the broken armor. The bridging element may further function as an element to add preferential bend to the flexible cable assembly. The bridging element may further function to as a fiber transition guard to protect the fibers from crush. Alternative armored cable assemblies may include keeping the armor electrically intact while still accessing the fibers within, for example, windowing the armor. Windowing armor eliminates the need for an electrical bridging element such as a wire or braided grounding strap.

Referring to all embodiments and the flexible overmold 42, the overmold can be bent with a force about equal to the force required to bend the cable itself (the cable to which the overmold is attached) without the overmold 42 attached. The overmold preferably has an outer diameter sufficiently small enough to allow the assembly to be installed in buried and aerial networks through any conduit or duct, or over aerial installation sheave wheels and pulleys. Intrinsic properties of the overmold material contribute to its flexibility, and in some embodiments, the geometric shape of the overmold and the positioning of strength components and bend elements within contribute to controlled stiffness.

To create an access point on a cable containing at least one buffer tube, an appropriate buffer tube may be accessed in multiple places using a standard No-Slack Optical Fiber Access Tool (NOFAT) available from Corning Cable Systems LLC of Hickory, N.C. The NOFAT tool is suitable for use in locations in which a limited amount of cable slack can be obtained and the buffer tubes remain helically wrapped around a central member. While selected optical fibers are preterminated, uncut fibers remain intact and continue through the distribution cable, possibly being preterminated at another access point. In some embodiments, a water-blocking wrap and/or a protective layer may be added around the access point prior to overmolding. Overmolding typically involves preparing the sheath of the distribution cable, such as by cleaning and roughening, flame preparing or chemically preparing the surface. The assembly is placed into an overmolding tool and the flowable material is introduced into a mold cavity defined by the molding tool.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. The material and physical properties of the overmold materials and methods of overmolding may also be modified so long as the assembly remains flexible and the fibers and splices within do not significantly attenuate when exposed to stress.

What is claimed is:

1. A fiber optic cable assembly, comprising:
a fiber optic cable having a plurality of optical fibers disposed within a cable sheath and having an access point through the cable sheath for accessing and preterminating at least one of the plurality of optical fibers;
at least one tether attached about the access point, the at least one tether having at least one optical fiber disposed within a cable sheath; and
a flexible closure substantially encapsulating the access point, a portion of the fiber optic cable and a portion of the at least one tether;
wherein at least one preterminated fiber of the fiber optic cable is spliced to the at least one optical fiber of the at least one tether; and
wherein spliced together fiber portions of the at least one preterminated fiber and the at least one tether optical fiber are not maintained within a splice tube.

2. The fiber optic cable assembly according to claim 1, wherein the spliced together fiber portions are wrapped about the plurality of optical fibers of the fiber optic cable.

3. The fiber optic cable assembly according to claim 1, wherein the spliced together fiber portions are wrapped in a first direction and then wrapped in a reverse direction about the plurality of optical fibers of the fiber optic cable.

4. The fiber optic cable assembly according to claim 1, wherein the assembly includes at least a first tether attached and exiting about a first end of the access point and a second tether attached and exiting about a second end of the access point.

5. The fiber optic cable assembly according to claim 1, wherein the spliced together fiber portions of optical fibers are nanostructured optical fibers.

6. The fiber optic cable assembly according to claim 1, further comprising a preferential bend element having a predetermined shape to provide variable preferential stiffness.

7. The fiber optic cable assembly according to claim 1, wherein the fiber optic cable further comprises armor and wherein the armor at the access location is broken and electrically bridged using a bridging element.

8. The fiber optic cable assembly according to claim 7, wherein the bridging element also functions as a preferential bend element.

9. The fiber optic cable assembly according to claim 1, wherein the spliced together fiber portions are covered with a viscous boundary layer.

10. The fiber optic cable assembly according to claim 9, wherein the cable assembly further comprises a trough that provides a location to apply the viscous boundary layer.

11. A fiber optic cable assembly, comprising:
a fiber optic cable having a plurality of optical fibers disposed within a cable sheath and having an access point through the cable sheath for accessing and preterminating the plurality of optical fibers;
at least one tether attached about a first end of the access point and comprising at least one optical fiber disposed within a cable sheath;
at least one tether attached about a second end of the access point and comprising at least one optical fiber disposed within a cable sheath; and
a flexible closure substantially encapsulating the access point, a portion of the fiber optic cable and a portion of the at least one tethers;
wherein preterminated fibers of the fiber optic cable are spliced to the at least one optical fibers of the at least one tethers; and
wherein spliced together fiber portions are not maintained within a splice tube.

12. The fiber optic cable assembly according to claim 11, wherein the spliced together fiber portions are wrapped about the plurality of optical fibers of the fiber optic cable.

13. The fiber optic cable assembly according to claim 11, wherein the spliced together fiber portions are nanostructured optical fibers.

14. The fiber optic cable assembly according to claim 11, further comprising a preferential bend element having a predetermined shape to provide variable preferential stiffness.

15. The fiber optic cable assembly according to claim 11, wherein the fiber optic cable further comprises armor and wherein the armor at the access location is broken and electrically bridged using a bridging element.

16. The fiber optic cable assembly according to claim 15, wherein the bridging element also functions as a preferential bend element.

17. The fiber optic cable assembly according to claim 11, wherein the spliced together fiber portions are covered with a viscous boundary layer.

18. The fiber optic cable assembly according to claim 17, wherein the cable assembly further comprises a trough that provides a location to apply the viscous boundary layer.

19. A fiber optic cable assembly, comprising:
a fiber optic cable having a plurality of optical fibers disposed within a cable sheath and having an access point through the cable sheath for accessing and preterminating at least one of the plurality of optical fibers;
at least one tether attached about the access point, the at least one tether having at least one optical fiber disposed within a cable sheath; and
a protective covering over the access location;
wherein at least one preterminated fiber of the fiber optic cable is spliced to the at least one optical fiber of the at least one tether;
wherein spliced together fiber portions of the at least one preterminated fiber and the at least one tether optical fiber are not maintained within a splice tube; and
wherein the spliced together fiber portions are wrapped about a core of the fiber optic cable.

20. The fiber optic cable assembly according to claim 19, wherein the fiber optic cable further comprises armor and wherein the armor at the access location is broken and electrically bridged using a bridging element.
